(19) United States
(12) Patent Application Publication
(10) Pub. No.: US 2011/0310064 A1
(43) Pub. Date: Dec. 22, 2011

(54) User Interfaces and Associated Apparatus and Methods

(75) Inventors: Turo Hermanni Keski-Jaskari, Vantaa (FI); Marko Kalervo Karhiniemi, Espoo (FI)

(73) Assignee: NOKIA CORPORATION, Espoo (FI)

(21) Appl. No.: 12/666,258

(22) PCT Filed: Jun. 25, 2007
(86) PCT No.: PCT/EP2007/005582

§ 371 Date: Aug. 20, 2010

(51) Int. Cl. G06F 3/041

(52) U.S. Cl. 345/178

(57) ABSTRACT

Apparatus for a touch sensor, the apparatus comprising circuitry for processing signaling to determine the detection of touch input, wherein the circuitry for processing is arranged to detect touch input by comparing touch signaling with one or more reference thresholds, and wherein the circuitry for processing is arranged to perform a first touch calibration, following the detection of the first touch, to provide a first reference threshold which compensates for the signaling associated with the first touch, and wherein the circuitry for processing is arranged to detect a subsequent next touch, using the first reference threshold, as the reference threshold for detection of said next subsequent touch.

### TECHNICAL FIELD

The present invention relates to the field of user interfaces, and in particular, touch user interfaces, including so-called capacitive touch pads. Such (e.g. capacitive) touchpads may be dedicated user input keypads which are not part of a display, or may be comprised with a display such that they detect user input over the display (i.e. a “touchscreen”). Associated apparatus (including touch sensor modules for devices) and portable electronic devices, and associated methods are also within the scope of the present invention.

### BACKGROUND

A touchpad is an input device commonly used in laptop computers, but also increasingly used in portable electronic devices such as Portable Digital Assistants (PDAs), including so called mobile phones. They are used to detect user input, and possibly also used to move a cursor, using motions of the user's finger (or a suitable pen/stylus). In the case of a laptop, they are a substitute for a computer mouse. Touchpads vary in size but are currently rarely made larger than 20 square centimetres (about 3 square inches).

In general, touchpads operate by sensing the capacitance of a finger (or other suitable input device e.g. appropriate stylus to cause a change in detected capacitance), or the capacitance between sensors. Capacitive sensors (comprising conductive elements) are laid out along the horizontal and vertical axes of the touchpad. The location of the finger is determined from the pattern of capacitance from these sensors. In the case of using a pencil, as the pencil tip is small and also because the pencil is not conductive, the effect on the electric field is minimal and therefore the capacitive sensors will not sense the tip of a pencil or other similar implement.

Touchpads can be used to detect relative motion, such that relative motion of the user's fingers can be used to cause relative motion of the cursor. In such cases, the touch sensors most often detect the absolute position of the finger, and appropriate software is used to determine motion of the cursor. Depending on the model of touchpad and drivers behind it, you may also click by tapping your finger on the touchpad, and drag with a tap following by a continuous pointing motion (a ‘click-and-a-half’).

Some touchpads also have so called “hotspots” (i.e. specific predefined areas): locations on the touchpad that indicate user intentions other than pointing. For example, on certain touchpads, moving your finger along the right edge of the touch pad will control the scrollbar and scroll the window that has the focus vertically. Moving the finger on the bottom of the touchpad often scrolls in horizontal direction.

There are two principal means by which capacitive touchpads work; a so-called “matrix approach” and a “capacitive shunt method”.

In the ‘matrix approach’ (i.e. a matrix type touch sensor), a series of conductors are arranged in an array of parallel lines in two layers, separated by an insulator. The conductors in these layers are oriented orthogonally to one another. A high frequency signal is applied sequentially between pairs in the two dimensional matrix created by the conductor array. The current that passes between the nodes is proportional to the capacitance. When a virtual ground, such as the finger, is placed over one of the intersections between the conductive layer some of the electrical field lines are shunted to this ground point, resulting in a change in the apparent capacitance at that location. This method received U.S. Pat. No. 5,305,017

The ‘capacitive shunt method’ senses the change in capacitance between a transmitter and receiver that are on opposite sides of the sensor. The transmitter creates an electric field which oscillates at 2-300 kHz. If a ground point, such as the finger, is placed between the transmitter and receiver, some of the field lines are shunted away, decreasing the apparent capacitance.

Capacitive touchpads which operate using an impedance measurement principle (i.e. the “matrix approach”) are easy and cheap, but it normally just averages the point of contact to centre of mass, and cannot distinguish two separate points of contacts (i.e. multi-touch). In many applications, a multi-touch feature is very useful, for example, pressing a shift key and then another key. US20050046621A1 provides for recognizing two points from an averaging touch screen, but it is based on the rapid change of the position, after which the first position is evaluated to be the first position, and the second is evaluated from the change of the measured position. Thus, the teachings of this document may be considered to be a “pseudo-method” to evaluate the other point, and may not provide accurate results, for example, with very rapid movements.

There are many ways in which one can utilise capacitive signal detection to measure touch. It should also be appreciated that the matrix method is sometimes defined by the sensor arrangement and/or sensor arrangement and measurement principle. However, in general, there are several measurement implementations, which vary in measurement principle as well as sensor electrode arrangement. These different measurement principles and sensor arrangements form different electric fields around the electrodes, with which the object (e.g. a finger or a stylus) interferes. The measurement of this interference can be detected by a specific measurement arrangement and corresponding method.

Due to the nature of electric field and the proximity of multiple electrodes, the object usually affects the signal detected by multiple electrodes, which can be problematic particularly in detecting “multiple touch”. This is particularly so in the case that only a few electrodes are used, and the measurement principle averages the whole detected capacitance over a touch surface. This “averaging or shadow” effect can be compared to detecting the central mass point of an object.

A good example of an averaging capacitance measurement arrangement is a semi-conductive (e.g. 50 Ohm/square-500 kOhm/square) touch surface, where the capacitance signal over the surface is measured e.g. from four corners. This is what is often called impedance measurement because it uses the semi-conductive surface which has a capacitive connection to the finger. The measurement principle is described in U.S. Pat. No. 6,466,036 (a pulse circuit for measuring the capacitance to ground of a plate), and can also be applied to touch surfaces having semi-conductive plane.

In short, this measurement principle uses the injection of charge pulses from a number of electrodes (at least three, advantageously at least four) placed around the touch plane. Increased numbers of electrodes can be used for increased accuracy and performance. These charge pulses generate electric field around the semi-conductive plane, and the finger absorbs some of the pulses (capacitive connection to the plane). The injected charges are collected and counted to determine how many of those are needed for reaching the threshold level. The sensing electrodes from the corners of the touch plane have resistance values to the point which forms the capacitance connection to the finger. Relative resistance values determine the distances from the corners to provide coordinate values. Linearity correction can be done via software, but there exists some HW solutions as well: ITO striping (US publication US 2006/0207806) and linearization patterning at the edges of the foil.

A further example of a measurement principle which can be used with a matrix type of grid sensor arrangement is described in U.S. Pat. No. 6,452,514.

The listing or discussion of a prior-published document in this specification should not necessarily be taken as an acknowledgement that the document is part of the state of the art or is common general knowledge. The present invention may use one or more of the discussed measurement principles or other measurement principles not discussed. The present invention may not necessarily be limited to capacitive touch sensors, or touch sensors known at the time of filing.

### SUMMARY

In a first aspect, there is provided an apparatus for a touch sensor, the apparatus comprising:
circuitry for processing signaling to determine the detection of touch input, wherein the circuitry for processing is arranged to detect touch input by comparing touch signaling with one or more reference thresholds, and wherein the circuitry for processing is arranged to perform a first touch calibration, following the detection of the first touch, to provide a first reference threshold which compensates for the signaling associated with the first touch, and wherein the circuitry for processing is arranged to detect a subsequent next touch, using the first reference threshold, as the reference threshold for detection of said next subsequent touch.

The circuitry for processing may be arranged to perform a first touch calibration, following the detection of the first touch, to provide a first reference threshold which compensates for the signaling associated with the first touch, and the circuitry for processing may be arranged to detect a next second touch, using the first reference threshold, as the reference threshold for detection of said next second touch.

The first touch may be the very first touch in a sequence of touches, or an intermediate touch in a sequence of touches.

The circuitry for processing may be arranged to perform a second reference calibration, following the detection of the first touch, to provide a second reference threshold which compensates for the signaling associated with the second touch, and the circuitry for processing may be arranged to detect a next third touch, using the second reference threshold, as the reference threshold for detection of said next third touch.

This second reference threshold would also inherently compensate for the signaling associated with the first touch as the second touch was detected based on compensation for the signaling associated with the first touch.

The circuitry for processing may be for a touch sensor comprising a plurality of regions defined for a user, and the first touch may be associated with user touch of one of the regions defined for a user, and the second touch may be associated with user touch of another one of the regions defined for a user.

The regions defined for a user may comprise respective key regions, for example, of a (e.g. QWERTY) keyboard-type user interface.

The circuitry for processing may be for a touch sensor comprising a particular region defined for a user, and the first touch and one or more subsequent touches may be associated with multiple selections using the same region for a user.

The first touch may be arranged to be associated with the provision of a menu of options for user selection, and a subsequent touch may be associated with the selection of one of the menu options.

The touch sensor may be arranged such that touch is associated with a reduction in detected capacitance. The reduction in detected capacitance may be associated the provision of additional signaling compared to when touch is not detected. The detection of touch may be associated with additional signaling compared to when touch is not detected.

The circuitry for processing signaling may be arranged to detect touch input, based upon additional signaling associated with touch, and to provide the first reference threshold by compensating for the additional signaling associated with the first touch.

The circuitry for processing may be arranged to remove the additional signaling associated with the first touch to provide the first reference threshold.

The circuitry for processing may be arranged to perform an environment calibration to provide an environment reference threshold to be used in the detection of said first touch. The environmental calibration may compensate for the effect of one or more of device covers, the sensor layout, the PCB underneath the sensor, wirings, metal parts, user's hand(s), etc on the touch detection mechanism/measurement principle.

The apparatus may be arranged to automatically perform the environment calibration upon powering up of the apparatus. The apparatus may be arranged to perform the environment calibration at predefined intervals following powering up of the apparatus. The apparatus may be arranged to perform the environment calibration continuously following powering up of the apparatus until a first touch is detected.

The apparatus may be arranged to store one or more reference thresholds in associated memory circuitry.

The circuitry for processing may be arranged to wait for a predetermined time period, following the detection of the first touch, before performing the first touch calibration.

The apparatus may comprise circuitry for providing signaling to determine the detection of touch input.

The apparatus may be for a matrix type touch sensor.

The circuitry for providing signaling to determine the detection of touch input may comprise first and second mutually displaced dipole electrode pairs, the pairs arranged orthogonal to one another, to act as sensors to detect changes in capacitance.

The circuitry for providing signaling to determine the detection of touch input may comprise a pulse circuit for measuring the capacitance to ground of a plate.

The apparatus may be for a capacitive shunt method touch sensor.

The apparatus may comprise a touchpad to provide a surface which can be used in the detection of touch input.

In a second aspect, there is provided a touch sensor comprising the apparatus for a touch sensor.

In a third aspect, there is provided a device comprising the apparatus for a touch sensor.

In a fourth aspect, there is provided a module for a device, the module comprising the apparatus for a touch sensor.

In a fifth aspect, there is provided a method for the detection of a plurality of touches using a touch sensor apparatus, the method involving the detection of touch input by comparing touch signaling with one or more reference thresholds, wherein the method comprises performing a first touch calibration, following the detection of a first touch, to provide a first reference threshold which compensates for the signaling associated with the first touch, and using the first reference threshold as the reference threshold for detection of a next subsequent touch.

In a sixth aspect, there is provided a computer program comprising computer code arranged to provide the detection of a plurality of touches using a touch sensor, the computer code arranged to detect touch input by comparing touch signaling with one or more reference thresholds, wherein the computer code is arranged to perform a first touch calibration, following the detection of a first touch, to provide a first reference threshold which compensates for the signaling associated with the first touch, and use the first reference threshold as the reference threshold for detection of a next subsequent touch.

Associated methods of assembly of apparatus/devices are also provided.

In a seventh aspect, there is provided an apparatus for a means for touch sensing, the apparatus comprising:

means for processing signaling to determine the detection of touch input, wherein the means for processing is arranged to detect touch input by comparing touch signaling with one or more reference thresholds, and wherein the means for processing is arranged to perform a first touch calibration, following the detection of the first touch, to provide a first reference threshold which compensates for the signaling associated with the first touch, and wherein the means for processing is arranged to detect a subsequent next touch, using the first reference threshold, as the reference threshold for detection of said next subsequent touch.

The circuitry for processing may be processing circuitry and the circuitry for providing signaling to determine the detection of touch input may be touch input detection circuitry.

It will be appreciated that one or more aspects/embodiments provide that after a recognised “touch event”, the whole measured (e.g. capacitive) field around the sensor will be compensated so that the touching finger becomes part of the environment i.e. part of the background. This would involve the updating of the threshold to provide a new compensated threshold. Whereas the original environment calibration (prior to the first touch) would take account of the impact of, for example, any device covers, the holding hand, etc, following the “first touch event”, the impact of the first touch on the measured (e.g. capacitive) field would also be considered to be part of the background following the first touch, and be used to assess whether there has been a subsequent second touch.

The present invention includes one or more aspects, embodiments or features in isolation or in various combinations whether or not specifically stated (including claimed) in that combination or in isolation. Corresponding means for performing one or more of the functions discussed are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1 illustrates a model showing how a matrix type touch sensors according to the prior art detects multiple touches;

FIG. 2 illustrates a model showing how a matrix type touch sensor according one embodiment of the present invention detects multiple touches;

FIG. 3 compares the capacitive signaling level in the prior art of FIG. 1 (FIG. 3a) with that of the embodiment of FIG. 2 (FIG. 3b);

FIG. 4 shows an application of a touch sensor according to one embodiment of the present invention;

FIG. 5 shows a schematic representation of a touch sensor according to one embodiment of the invention;

FIG. 6 shows some details of the circuitry for detecting touch of FIG. 5;

FIG. 7 shows the schematic representation of a capacitive shunt touch sensor which can be used in another embodiment of the present invention; and

FIG. 8 provides a flowchart of a method of calibration according to one embodiment.

### DESCRIPTION OF SPECIFIC EMBODIMENTS

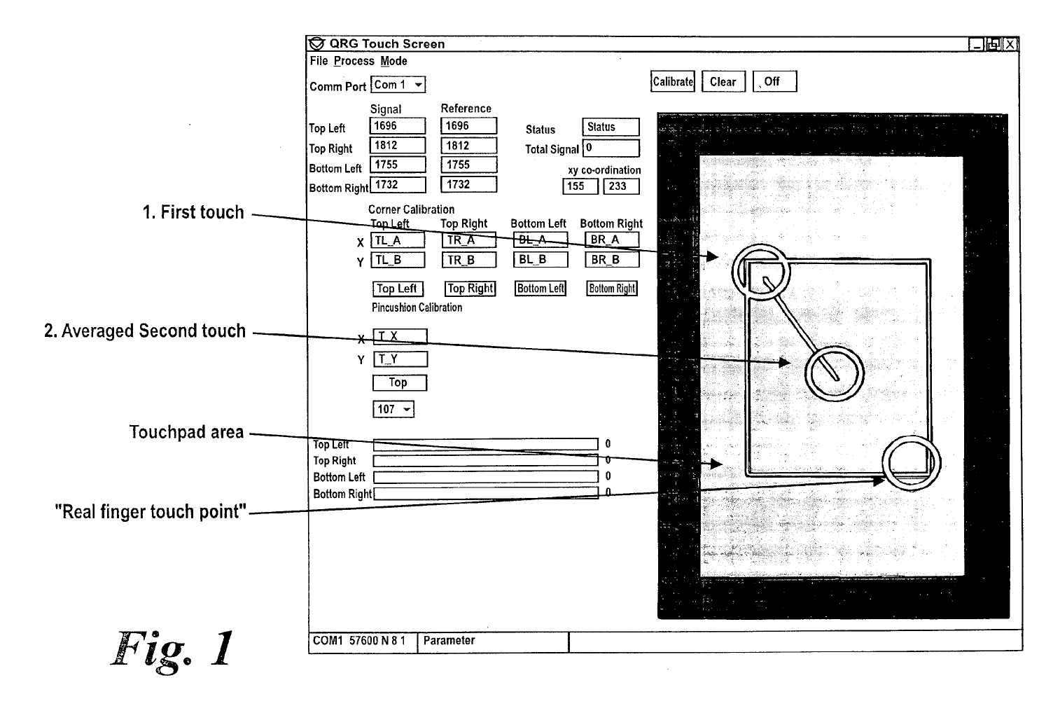

Before describing the operation of the present invention, it would be useful to understand how a matrix-type capacitive touch sensor according to the prior art detects multiple touches. This is modeled in FIG. 1.

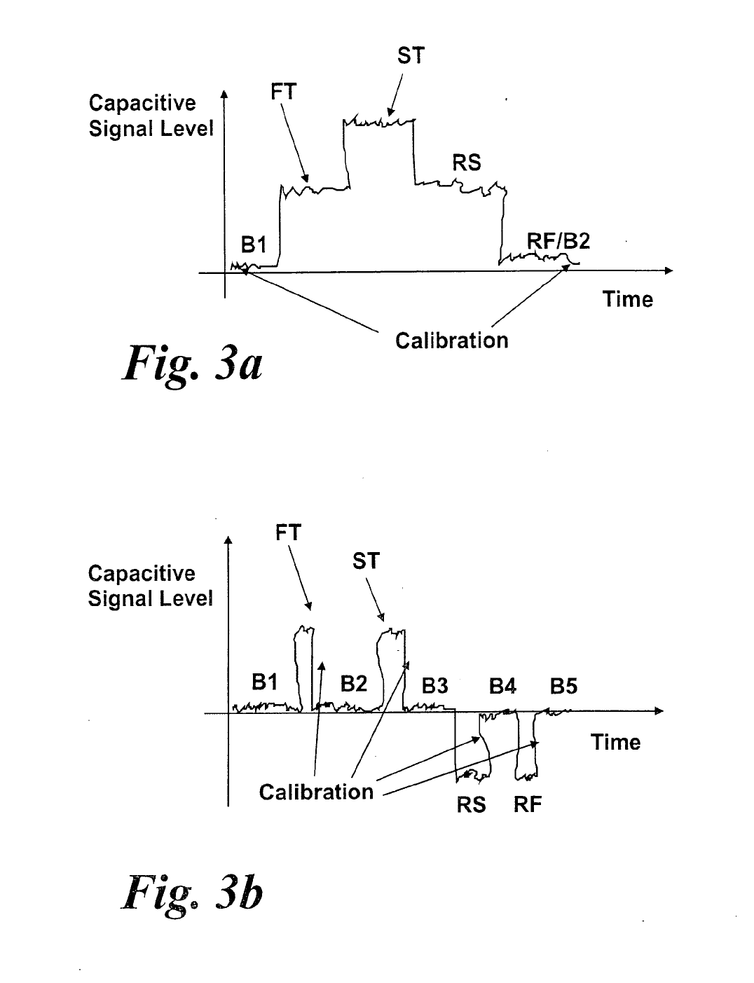

Firstly, the touch sensor performs an environmental (background) calibration some time prior to the detection of a first touch. This environmental calibration provides a reference threshold level ((B1, FIG. 3a)) of capacitance which is used to determine whether touch has been detected or not. If touch has been detected, then the detected capacitance changes (i.e. reduces) and the capacitance signal level detected changes (i.e. increases), signal level FT as shown in FIG. 3a. As shown in FIG. 3a, the capacitance signal level correspondingly increases with each additional touch (signal level ST), and correspondingly reduces which removal of each touch (signal level RS associated with the removal of the second touch (leaving the first touch only), and signal level RF/B2 with the subsequent removal of the first touch to a second background level). Once all touches have been removed, the capacitive signal level reverts to (or very near to) that associated with the environmental (background) calibration (B1, B2). An environmental re-calibration may be required.

In the prior art, a first touch is correctly detected (see FIG. 1). However, when a user at the same time touches the touchpad in a different region (“real finger touch point” of FIG. 1), the touch sensor “averages” the capacitance measurement and incorrectly assumes that the user has touched the touchpad in a region equidistant between the actual first and second touches (i.e. the averaged second touch). In other words, the detected second touch shown in FIG. 1 does not correspond to the actual second touch, but an average of the two touch positions. In the prior art, both touches are determined based on changes in detected capacitance level compared to the originally determined environmental reference threshold. The environmental threshold is not reset between touches.

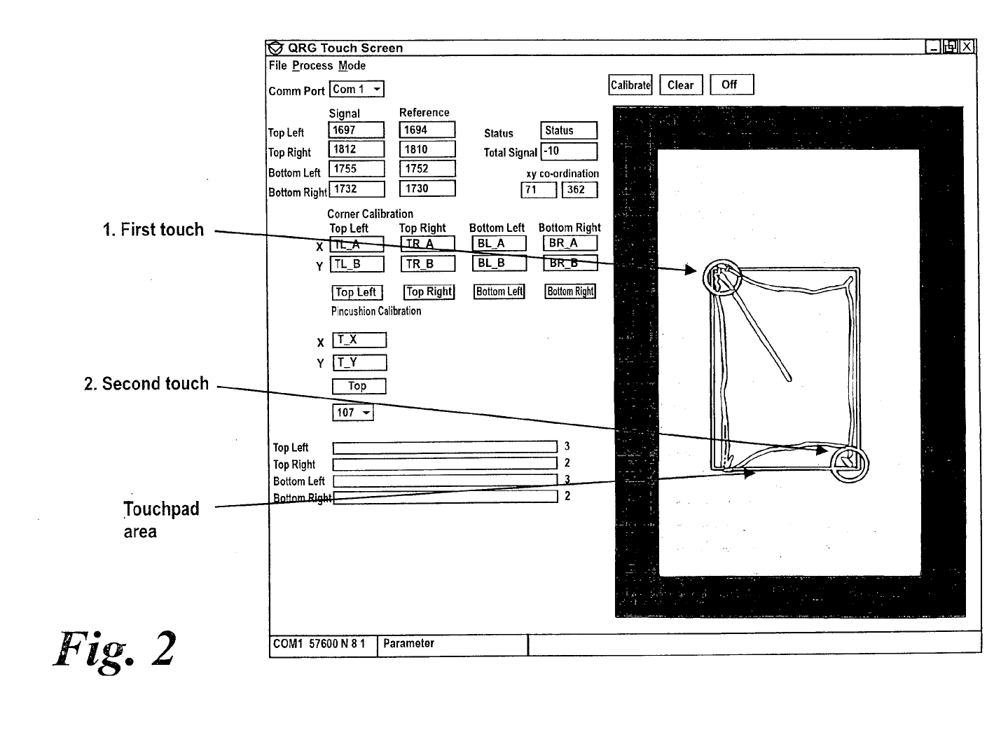

In accordance with one embodiment of the present invention (FIG. 2, and FIG. 3b), the touch sensor does not average the two touch positions. As in the case of the touch sensor of FIG. 1, the first touch (FT) is determined based on a comparison of the detected capacitance level with the environmental reference threshold (i.e. comparison with a previous reference threshold B1).

However, following detection of the first touch FT (and registering of the position of the first touch), a further calibration is performed. This second calibration takes into account the impact of the first touch on the detected capacitance signal level (and can be considered to reset the background capacitive signal level, or provide a new background level B2). This second calibration provides a new reference threshold B2 which is then used to determine whether a further touch (ST) is made. In this way, the two touches FT, ST can be individually detected (FIG. 3b). After detection of the second touch ST, a further calibration is performed to take into account the present of the second touch. This provides a further new background reference level B3. The new background reference level B3 is used to detect the removal of the second touch (RS). In this case, the capacitive signal level RS, following removal of the second touch, is detected to be negative compared to the reference threshold B3. A further reference calibration is performed following removal of the second touch to provide a new reference signal level B4 which is used to detect the subsequent removal of the first touch. Similarly, the removal of the first touch is detected as a negative signal level RF compared to the previous signal level B4. A further calibration is performed following the removal of the first touch to provide a new reference signal level B5.

In summary, following the calibration after the detection of the first touch input, the sensor “sees” the first touch point as a normal feature of the surrounding environment and ignores it. After that, any new signal change can lead to the position of the second finger. In this way, at least 2 different locations can be found with reasonable accuracy, which enables, for example, modifier (e.g. Shift/Ctrl) key+letter key combination usage, or an area selection from an image, for example. As explained, this principle can be applied to further subsequent touches by re-calibrating between respective touches. The touch sensor can be used in various devices, including PDAs, and audio/video players/recorders and other (in particular portable) electronic devices which require user interfaces.

It will be appreciated that additional operations can be applied with (e.g. at the same time, or following) one or more of the calibrations. For example, a coordinate map could be applied to the touch area to linearize, enhance performance or enable additional functionality. This can be based on the calibrated threshold value (the additional operations being performed if the threshold value changes by at least a predetermined amount). For example, if the calibration to the environment (i.e. the “vanishing the effect of finger”) is done, and the new threshold level is considered to be a significant change, then the additional operation are performed. Furthermore, a series of calibration can be performed (rather than a single calibration step), for example in the frequency of 10 Hz, to provide a averaged new threshold level.

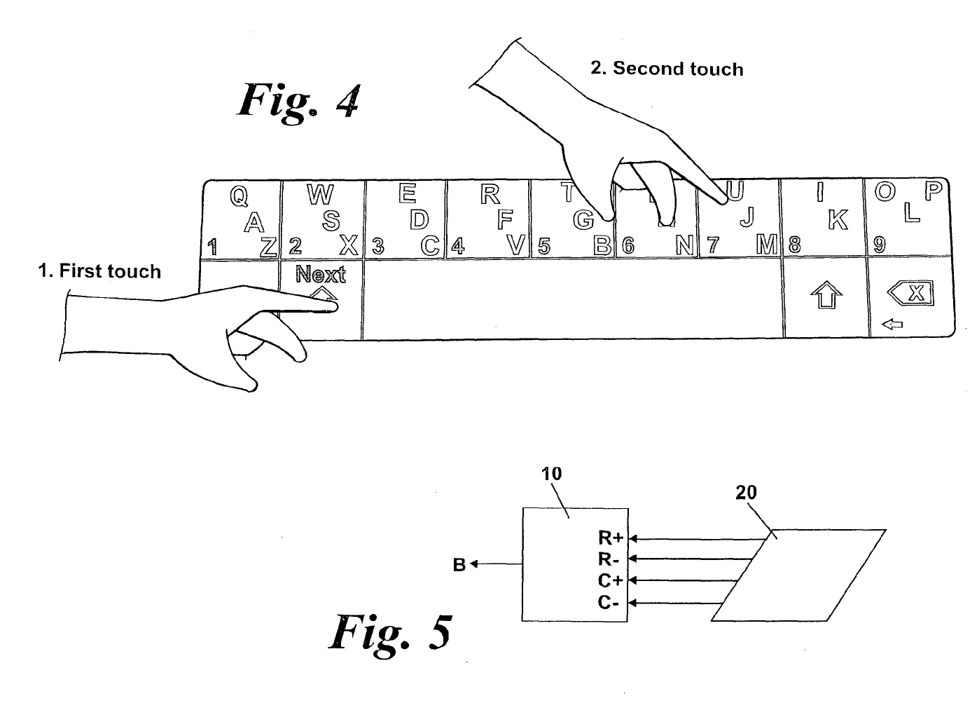

FIG. 4 shows a practical example of the use of a touch sensor according to one embodiment. The touch sensor can be advantageously used in providing QWERTY keyboard user input by defining specific regions on the touchpad surface associated with a particular entry value.

It is also possible for the present invention to be used in the touchpad of, for example, laptops allowing the performance of “right-click mouse options”. For example, a first touch could provide a menu of options on a display, which could be selected by a second subsequent touch on a different region of touchpad (these different regions not in-themselves being predefined to a user as different regions of the touch pad allowing for entry of a particular value associated with that particular region).

It will be appreciated that embodiments of the invention can be applied to existing types of touch sensors with modifications to software only (and with minimal, if any, modifications to hardware). The invention can also be applied to new types of touch sensors.

FIG. 5 shows a schematic illustration of a matrix type capacitive touchpad sensor 100 in accordance with one embodiment of the present invention. It comprises a capacitive touchpad sensor arrangement 20 (circuitry for detecting touch) and balance measurement and recalibration logic 10 (circuitry for processing the detection of touch).

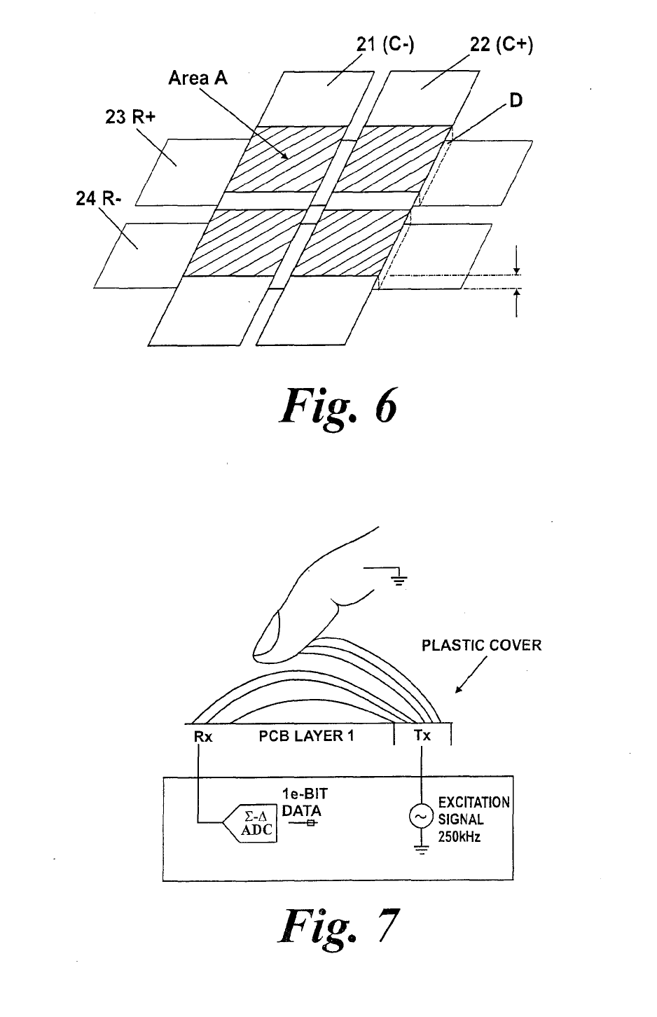

The capacitive touchpad sensor arrangement 20 comprises a touchpad surface (not shown) under which are laid a series of electrodes 21, 22, 23, 24 provided in respective layers in a mutually orthogonal matrix configuration. A dielectric material D is provided between the respective layers (FIG. 6). For simplicity, only one pair of electrodes are shown in each layer in FIG. 6. It will be appreciated that the pairs of electrodes overlie one another to define (in this case four) regions A which can act as capacitors.

As shown in FIG. 6, the conductive elements 21, 22, 23, 24 are configured in parallel pairs that form the columns and rows of a matrix configuration. The electrodes are arranged in adjacent dipole pairs such that capacitance signaling provided by the respective pairs are out of phase with one another. These electrodes are connected to the balance measurement and recalibration logic 10 through connections which provide capacitance signaling values R+, R−, C+ and C−.

The outputs of the touchpad sensor arrangement 20 are in an equilibrious state when under steady state conditions such as after boot up or when the device is held in a user's hand (i.e. following a calibration). Touch points between a grounded conductive element, such as a user's finger, and the touchpad sensor arrangement 20 are registered in both event and position by the balance output B. The output B can be considered to be the capacitive signal level of FIG. 3.

The balance measurement and recalibration logic 10 can be used to recalibrate the touchpad sensor arrangement 20 outputs R+, R−, C+ and C− after respective touch events (removal or addition of a touch) so as to return them to the equilibrium as experienced under steady state conditions (reset to the background level). Any subsequent touch point on the touchpad sensor arrangement 20 is “seen” by the balance measuring and recalibration logic 10 as a single touch point, and the position of the second touch can be calculated.

FIG. 7 shows a schematic representation of a capacitive shunt type method. Using this method, an excitation source is connected to a transmitter generating an electric field to a receiver. The field lines measured at the receiver are translated into the digital domain by a Σ-Δ converter. When a finger, or other grounded object, interferes with the electric field, some of the field lines are shunted to ground and do not reach the receiver. Therefore, the total capacitance measured at the receiver decreases when an object comes close to the induced field. As with the previous embodiment, a calibration can be performed following (e.g. each) touch event so as to account for the previous touch event when detecting the next touch event.

It should be noted that detection of a touch does not necessarily require a user to touch the touch pad surface. For example, a change in capacitance will be detected if the user finger approached near to the surface of the touchpad surface.

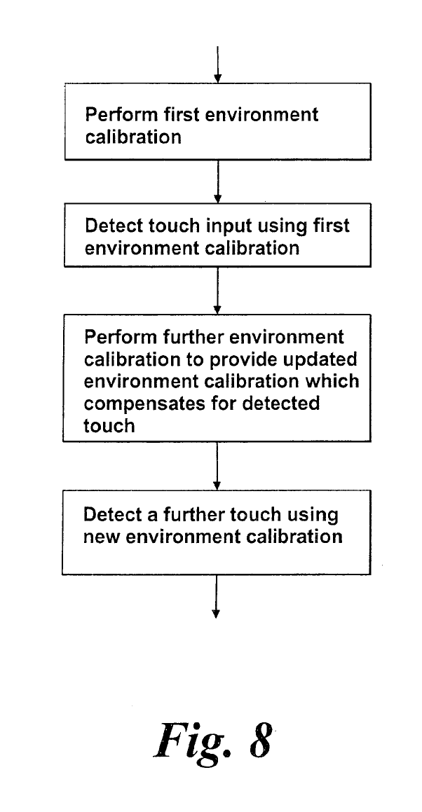

It will be appreciated that one or more aspects/embodiments provide that after a recognised “touch event”, the whole measured (e.g. capacitive) field around the sensor will be compensated so that the touching finger becomes part of the environment i.e. part of the background. This would involve the updating of the threshold to provide a new compensated threshold. Whereas the original environment calibration (prior to the first touch) would take account of the impact of, for example, any device covers, the holding hand, etc, following the “first touch event”, the impact of the first touch on the measured (e.g. capacitive) field would also be considered to be part of the background following the first touch, and be used to assess whether there has been a subsequent second touch (FIG. 8).

It will be appreciated that the aforementioned circuitry may have other functions in addition to the mentioned functions, and that these functions may be performed by the same circuit.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-24. (canceled)

25. An apparatus for a touch sensor, the apparatus comprising:
circuitry for processing signaling to determine the respective locations of multiple concurrent touch inputs, wherein the circuitry for processing is configured to:
perform a first touch calibration, following the detection of a first touch, to provide a first reference threshold which compensates for the signaling associated with the first touch, and
detect the location of a subsequent next concurrent touch, using the first reference threshold, as the reference threshold for detection of the location of said concurrent subsequent touch.

26. The apparatus according to claim 25, wherein the circuitry for processing is configured to perform a second reference calibration, following the detection of the first touch, to provide a second reference threshold which compensates for the signaling associated with the concurrent second touch, and wherein the circuitry for processing is configured to detect a next concurrent third touch, using the second reference threshold, as the reference threshold for detection of said next concurrent third touch.

27. The apparatus according to claim 25, wherein the circuitry for processing is for a touch sensor comprising a plurality of regions defined for a user, and wherein the first touch is associated with user touch of one of the regions defined for a user, and wherein the concurrent second touch is associated with concurrent user touch of another one of the regions defined for a user.

28. The apparatus according to claim 25, wherein the circuitry for processing is for a touch sensor comprising a particular region defined for a user, and wherein the first touch and one or more subsequent concurrent touches are associated with multiple selections using the same region for a user.

29. The apparatus according to claim 25, wherein the first touch is configured to be associated with the provision of a menu of options for user selection, and a subsequent concurrent touch is associated with the selection of one of the menu options.

30. The apparatus according to claim 25, wherein the circuitry for processing signaling is configured to:
detect touch input;
provide additional signaling associated with the detected touch input; and
provide a reference threshold corresponding to said detected touch by compensating for the additional signaling associated with said touch.

31. The apparatus according to claim 30, wherein the circuitry for processing is configured to remove the additional signaling associated with said touch to provide the corresponding reference threshold.

32. The apparatus according to claim 30, wherein:
the circuitry for processing is configured to detect touch input by detecting a reduction in detected capacitance caused by a touch input; and
the additional signaling associated with the detected touch input is configured to be representative of the detected reduction in detected capacitance caused by said touch input.

33. The apparatus of claim 25, wherein the circuitry for processing is configured to detect touch input by detecting a reduction in detected capacitance caused by a touch input.

34. The apparatus of claim 25, wherein the circuitry for processing is configured to:
detect touch input by detecting a reduction in detected capacitance caused by a touch input;
provide additional signaling associated with the detected touch input, the additional signaling being configured to be representative of the detected reduction in detected capacitance caused by said touch input; and
provide a reference threshold corresponding to said detected touch by compensating for the additional signaling associated with said touch.

35. The apparatus according to claim 25, wherein the circuitry for processing is configured to perform an environment calibration to provide an environment reference threshold to be used in the detection of said first touch.

36. The apparatus according to claim 25, wherein the apparatus is for a matrix type touch sensor or a capacitive shunt method touch sensor.

37. The apparatus according to claim 25, wherein the circuitry for providing signaling to determine the detection of touch input comprises first and second mutually displaced dipole electrode pairs, the pairs configured orthogonal to one another, to act as sensors to detect changes in capacitance.

38. The apparatus according to claim 25, wherein the circuitry for providing signaling to determine the detection of touch input comprises a pulse circuit for measuring the capacitance to ground of a plate.

39. The apparatus according to claim 25, comprising a touchpad to provide a surface which can be used in the detection of touch input.

40. An apparatus according to claim 25, wherein the apparatus is a touch sensor, device, or module for a device.

41. A method for determining the locations of multiple concurrent touches using a touch sensor apparatus, wherein the method comprises:
performing a first touch calibration, following the detection of a first touch, to provide a first reference threshold which compensates for the signaling associated with the first touch, and
detecting the location of a subsequent next concurrent touch, using the first reference threshold as the reference threshold for detection of the location of said subsequent concurrent touch.

42. A computer program comprising computer code that is configured to, when run, determine the locations of multiple concurrent touches using a touch sensor, wherein the computer code is configured to perform the steps of:
performing a first touch calibration, following the detection of a first touch, to provide a first reference threshold which compensates for the signaling associated with the first touch, and
detecting the location of a subsequent next concurrent touch, using the first reference threshold as the reference threshold for detection of the location of said concurrent subsequent touch.

43. A method of assembling an apparatus according to claim 25.
